(19) United States
(12) Patent Application Publication
(10) Pub. No.: US 2008/0082344 A1
(43) Pub. Date: Apr. 3, 2008

(54) Electronic automated real estate appraisal information exchange and management system

(75) Inventor: Darnell Jamar Parker, Mableton, GA (US)

Correspondence Address: DARNELL J. PARKER, 6103 FARMWOOD WAY, MABLETON, GA, 30126, US

(73) Assignee: Parker Meridian Inc., Mableton, GA (US)

(21) Appl. No.: 11/485,200

(22) Filed: Oct. 3, 2006

(51) Int. Cl. G06F 17/40; G06F 17/30; G06Q 99/00

(52) U.S. Cl. 705/1; 707/104.1; 707/3

(57) ABSTRACT

A computer implemented system is provided in order to manage the exchange of information through three databases. The system is particularly useful for an appraisal management environment or other environments, which require an exchange between individuals in two or more categories such as consumers and appraisers. According to the preferred configuration, the system manages a database of real estate appraisals job postings. Each posting is stored in a job record, and the system is capable of searching on a plurality of keys in the consumer record to identify a real estate appraiser job record suitable to a particular appraiser. The system then facilitates creation of an appraisal record and designation of the appraisal record for an accessible appraisal base or a selected job record. The system permits query of a job base in order to identify real estate appraisals jobs for appraisers. Finally, this system prevents collusion between the consumer (mortgage company) and the appraiser by creating a mutually exclusive event.

### CROSS REFERENCE TO RELATED APPLICATIONS

This application claims the benefit of provisional patent application Ser. No. 60/679,330 filed May 10, 2005, the disclosure of which is incorporated herein by reference.

### BACKGROUND OF THE INVENTION

1. Field of the Invention

The present invention relates generally to matching of a schedule event over a computer network. More particularly, the present invention relates to a method, system, and program for matching appraisers and appraisers accepting the responsibility of performing appraisals job opportunities over the internet.

There are currently on-line real estate appraisal companies, which are accessible through the World Wide Web. For example, the In Depth Appraising places contact information in electronic format on a computer system accessible over the World Wide Web. There have been numerous appraisals web sites were contact information is displayed. These web sites generally post a description of an appraisal and request a response either via an electronic mail address or a postal address. However there has not been available a comprehensive system for managing real estate appraisals with an effective search engine; a secured appraisal management facility; accessible real estate job postings database; and a targeted appraisal submission system.

Furthermore traditional communication such as telephone and mail do not supply the tools necessary for real estate appraisers in the increasingly competitive environment driven by the technological advances of the last two decades. The Internet provides a new media that is accessible by consumers in a manner which permits rapid response and easy interaction.

U.S. Pat. No. 5,832,497 to Taylor discloses an electronic automated information exchange and management system. A computer-implemented system manages an exchange of information between job applicants and employers. A first database includes job postings, each which is stored in a job record. The system can search on a plurality of keywords in the job record. The system can then facilitate creation of a resume record and designation of the resume record for a separate resume database. The resume database can be searched to identify candidates for a particular employment position.

U.S. Pat. No. 5,978,768 to McGovern et al. discloses a computerized job search system and method of posting job openings using a computer network. The system allows an employer to advertise positions on the internet, directly receive resumes from prospective candidates, and efficiently organize and screen the received resumes. The system further includes the capability of monitoring employment advertisements for an individual job seeker and automatically notifying the job seeker when a position for which the job seeker is suitable becomes available. The system also allows multiple companies to advertise job positions at a single location accessible over the internet by a job seeker, and allows the job seeker to communicate directly with a particular company if the job seeker is interested in further information relating to a particular position at the company. Typically, this last feature involves providing at the company's website which may include specific details about the particular position.

While the foregoing and other systems facilitate individuals appraisals companies and local consumers information exchange over the Internet, such systems are generally directed to relatively early step in the appraisal search process, that is, the matching of the potential consumers for particular job. Because of this focus, significant limitations prevent such systems from being useful during other steps in the appraisals process, particularly relating to scheduling appraisals or multiple selections of appraisals. Further, even with respect to the matching of appraisers and consumers jobs, they systems described above the still payment.

It would be desirable for a system, method, or program to provide for an automated matching between specific available appraisal jobs and particular appraisers. It would further be desirable for such a system to be able to facilitate the preferred scheduled time by the consumer or selections between and appraiser and a consumer, such as a homeowner or mortgage company, and one or more representatives of a particular entity such as an appraiser. It would be still further being desirable to facilitate an information exchange between the appraiser and the consumer after the appraiser selects and accepts to perform the appraisal job opportunity.

2. Description of the Related Art

The work done still fails to describe a system which allows for consumers to submit via on-line access appraisals jobs and certified appraisers to accept the job.

The work done still fails to describe a system which allows for consumers to their preferred time to increase appraiser productivity, cycle time, and consumer satisfaction.

The work done still fails to describe a system which allows for the appraiser and consumer to establish a mutually exclusive event and relationship by monitoring relationships, behavior, and time.

Those skilled in the art will recognize there is a need to provide a on-line access system to consumers so they may submit appraisal jobs and appraisers may accept such jobs.

### SUMMARY OF THE INVENTION

The present invention overcomes the limitations described above, and achieves additional advantages, by providing for a method, system, or program for facilitation a matching of appraisers with appraisals available to perform, including facilitating the exchange of information relevant to the appraiser and/or to the specific opportunities, and facilitating the scheduling of the appraisal or multiple selections of appraisals.

The invention relates to a computer implemented system for real estate appraisals management and accepting submissions in response to such real estate appraisals job postings. More particularly, the invention relates to a system for real estate appraisals job postings which includes a search mechanism and which allows consumers to submit, via on-line access, appraisals jobs and certified appraisers accept the job. The system may advantageously be accessible within a network, such as a local area network, a wide area network, or the Internet, in order to permit on-line access to a job database through a search engine; and to manage the application for such jobs and submission of real estate appraisal job postings, appraiser information and other relevant information

Thus it is the primary object of this invention to provide a computer implemented system for posting and searching through real estate appraisal job postings. It is a further object of the invention to provide an on-line real estate appraisal management system. It is a further object of the invention to provide an on-line real estate appraisal submission system. It is a further object of the invention to provide a computer implemented system to assist in mortgage or loan process. It is a further object of the invention to provide a computer implemented system which links consumer information, in electronically readable memory, concerning appraisals to an electronic appraiser also stored in memory. It is a further object of the invention to provide an iterative job search engine. It is a further object of the invention to provide an on-line system for collecting consumer information and real estate appraiser information. It is a further object of the invention to provide an on-line real estate appraisal and real estate appraisal job search engine.

The invention may be implemented in a computer system whose actions are directed by a computer program configured as a multiple database information exchange management system. The system includes a first database stored in electronically readable memory (consumer base) and a second database store in electronically readable memory (appraisal base). The system also includes a communication port suitable for transmitting and receiving data and instructions in the form of electrical signals, to and from remote computers and a database manager for creating and revising records of the first and second databases. The system may also include an iterative database query engine connected to the memory and a process controller connected to the database manager, the iterative data base query engine and the communication port. An accounting system may also be provided. The job base records may contain a plurality of search key fields. The iterative database query engine may include means for searching on a plurality of search key fields of a database for satisfaction of one or more conditions and means for reporting all variables in said search key fields of records which satisfy the search conditions. The search key fields may restrict the possible entries to a predetermined set of entries. The system may also include means for relating a record of the first database to a record of the second database by storing job record identification in a relation field of a job record. Alternatively, the relation may be accomplished by storing a real estate job posting record identification in a relation field of a job record or creating an entry in a relation table, stored in electronically readable memory, wherein the relation entry includes identification of a resume record and a real estate appraisal record.

A system according to the invention will operate to lead a consumer through certain steps and parameters to submit a real estate appraisal job, purpose of appraisal, requester, contact person, and type of appraisal. According to the invention, jobs may be identified by a string of parameters which may be used to effectively allow iterative searching and identification of suitable jobs even in extremely large job databases. According to the invention, the job base includes parameters which permit a search engine to select parameter choices. Establishing certain parameters such as type of appraisal or job location permits narrowing an extremely large database to a more manageable size. Once an appraisal job is selected, an appraiser may accept a job by accepting and acknowledging the real estate appraisal job on-line.

### BRIEF DESCRIPTION OF THE DRAWINGS

The present invention can be understood more fully by reading the following Detailed Description of Preferred Embodiments of the invention, in conjunction with the accompanying drawings in which:

FIG. 1 shows a schematic of the appraisal order process architecture in an electronic automated real estate appraisal information exchange and management system according to the present invention.

FIG. 2 is a flow diagram describing a method according to one embodiment of the present invention.

FIG. 3 shows a schematic of the appraisal payment process architecture in an electronic automated real estate appraisal information exchange and management system according to the present invention.

FIG. 4 is a flow diagram describing a mutually exclusive relationship between the appraiser and consumer in an electronic automated real estate appraisal information exchange and management system according to the present invention.

FIG. 5a is a flow diagram illustrating the method for the consumer ordering an appraisal according to the present invention.

FIG. 5b is a continuation of the flow diagram of FIG. 5a;

FIG. 5c is a continuation of the flow diagram of FIG. 5b;

FIG. 6 is a flow diagram illustrating the method for the consumer to verify the order was completed successfully according to the present invention.

FIG. 7 is a flow diagram illustrating the method for the appraiser to enter the authorization code according to the present invention.

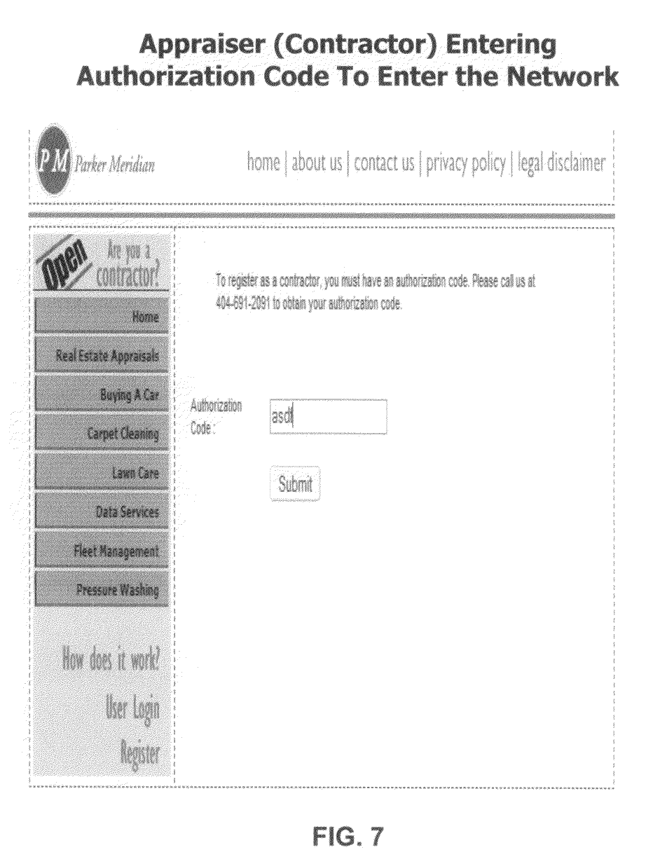

FIG. 8a is a flow diagram illustrating the method for the appraiser to register according to the present invention.

FIG. 8b is a continuation of the flow diagram of FIG. 8a;

FIG. 9 is a flow diagram illustrating the method for the appraiser to login with user name and password according to the present invention.

FIG. 10 is a flow diagram illustrating the method for the appraiser main menu according to the present invention.

FIG. 11 is a flow diagram illustrating the method for the appraiser search menu according to the present invention.

FIG. 12 is a flow diagram illustrating the method for the appraiser search by city according to the present invention.

FIG. 13 is a flow diagram illustrating the method for the appraiser reviewing an appraisal request according to the present invention.

FIG. 14 is a flow diagram illustrating the method for the appraiser to accept the appraisal and perform the appraisal service according to the present invention.

FIG. 15 is a flow diagram illustrating the method for the appraiser to verify the appraisal request is accepted with detailed information according to the present invention.

### DETAILED DESCRIPTION OF THE INVENTION

According to the invention, a process control unit will manage the flow of information through the system. A communication part is provided to allow access to the system through communications with other computers connected to the network. According to the preferred embodiment, the network may include access over the Internet to any number of external computer systems, electronic device, or access through local or wide area network to other connected computers either directly or through modems.

The system will include database memory provided to store the job base. The job base may be in the form of a data file comprised of a plurality of records, each record corresponding to a posted job. Each record will include a number of predefined fields containing search parameters and additional fields containing descriptive information of the type generally used in job postings.

In accordance with the preferred embodiment, the search parameters may include fields, such as: specified job location (preferably by zip code or state); type of appraisal; purpose of appraisal; requester; and contact person.

The types of appraisals listed is selected by the consumer. Types of appraisals include:

Full Appraisal

FHA Appraisal

VA Appraisal

2055 Without Inspection

2055 With Inspection

Relocation Report

Field Review

Desk Review

Examples of the purpose of appraisals may include:

Purchase

Refinance

PMI Removal

Estate Planning

Divorce

Set Sales

The job disciplines can be established so that each job can be cross-referenced to and identified by one or more values with a reasonable degree of specificity. An example of job disciplines for the single family is using the sale value of the subject property. Each appraisal job parameter field may be organized by geographical location with any desired amount of specificity. For a nationwide job indexing system, it may be convenient to specify location by state, county or zip code. For local appraisers, it may be more appropriate to specify location by county, city/town or zip code.

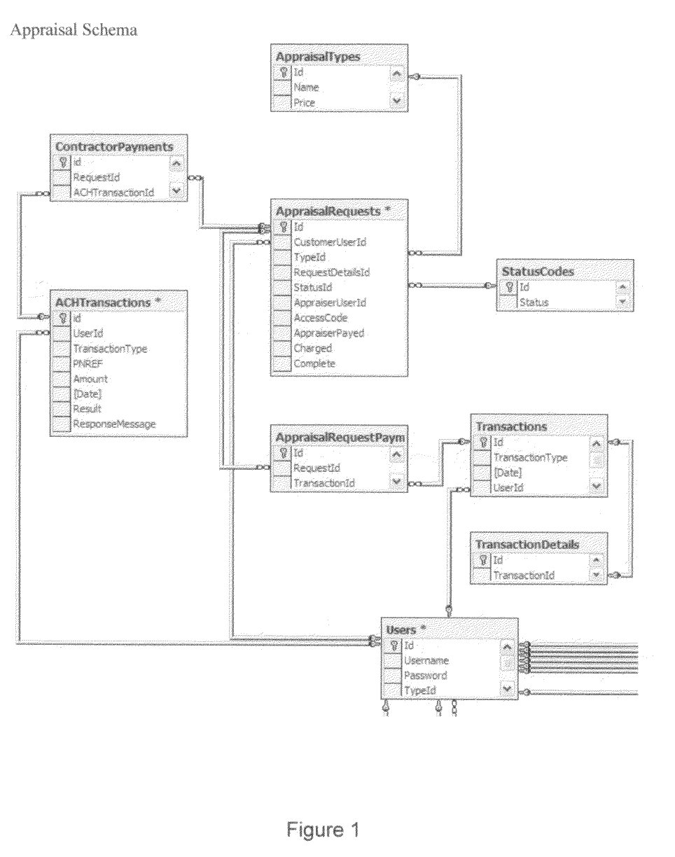

FIG. 1 shows a schematic of the system according to the invention. It is to be understood that the system can be implemented using general purpose computer hardware as a network site. The general purpose hardware may advantageously be in the form of a Unix workstation or other suitable computer. The hardware will be configured and customized by various software modules. The software modules will include communications software of the type conventionally used for Internet communications and a database management system. Any number of commercially available database management systems may be utilized to implement the invention. Those of ordinary skill in the art of database management application programming will be able to make and use the invention according to the disclosure hereof.

If a relational database management system is utilized, it would be advantageous to relate the consumers field of the job base to a consumer database file which will include relevant information, contact information and descriptions of appraisal job posting.

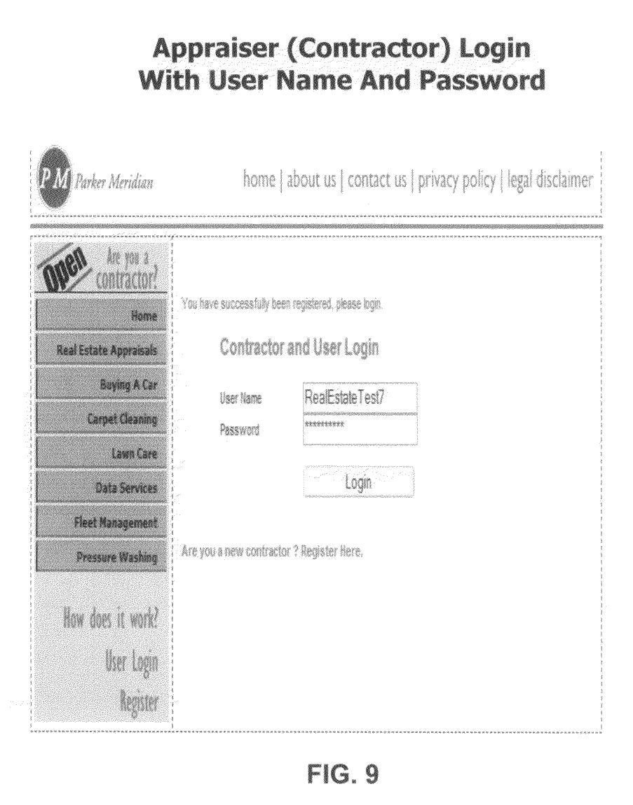

FIG. 9 shows the job base records will include some security or password fields which will specify who may have access to the job records for the purpose of posting, revising, maintaining, and deleting job records.

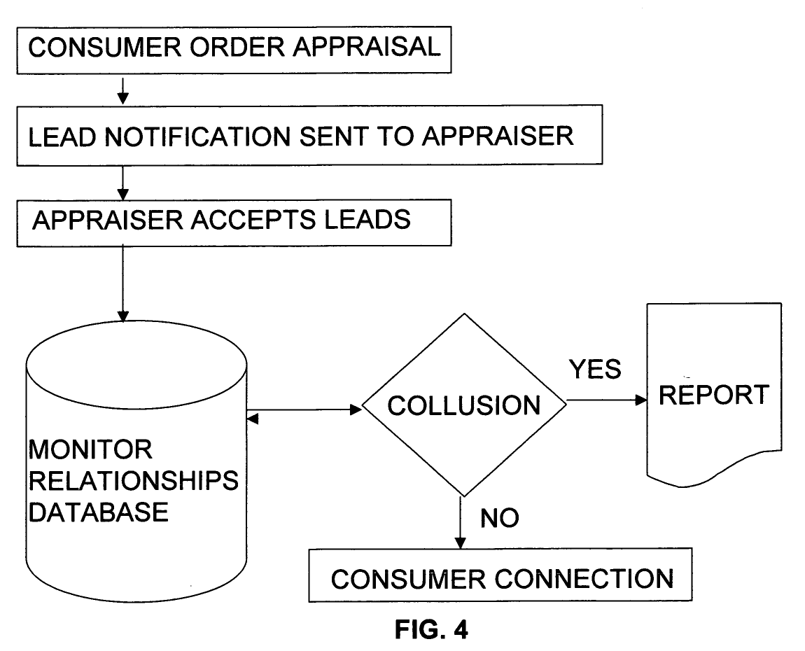

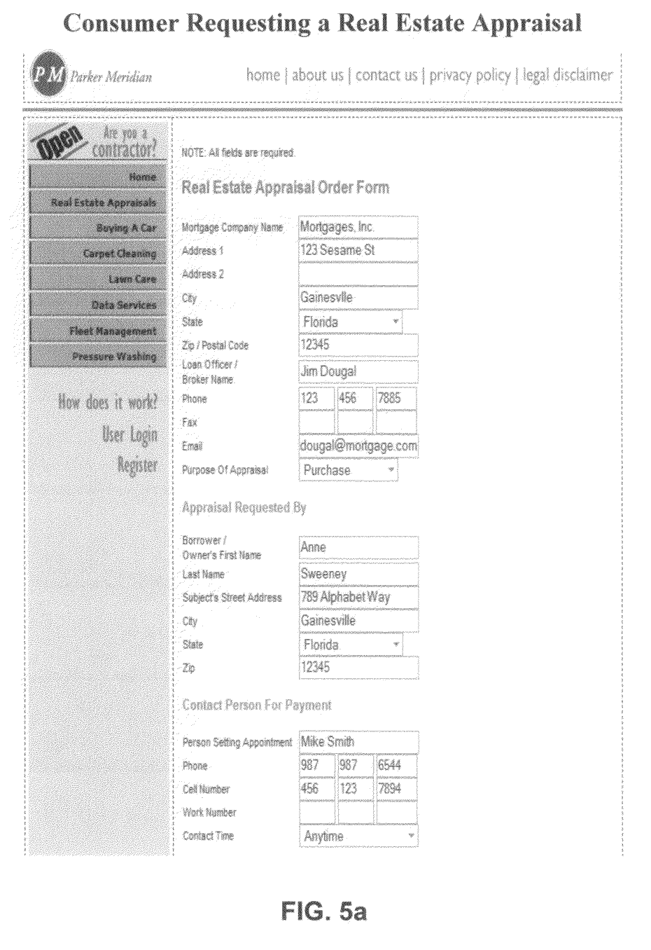

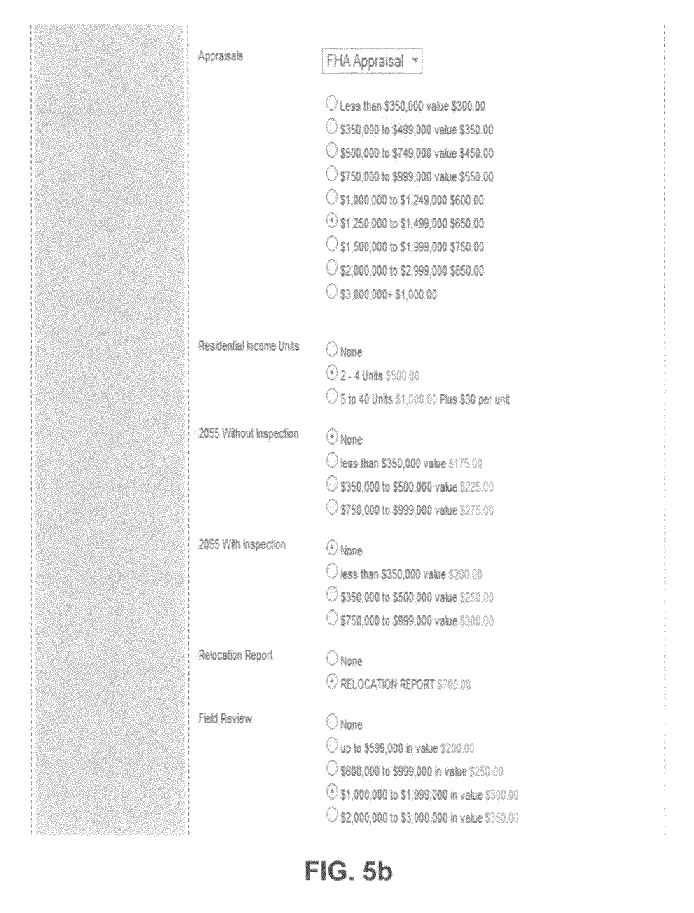

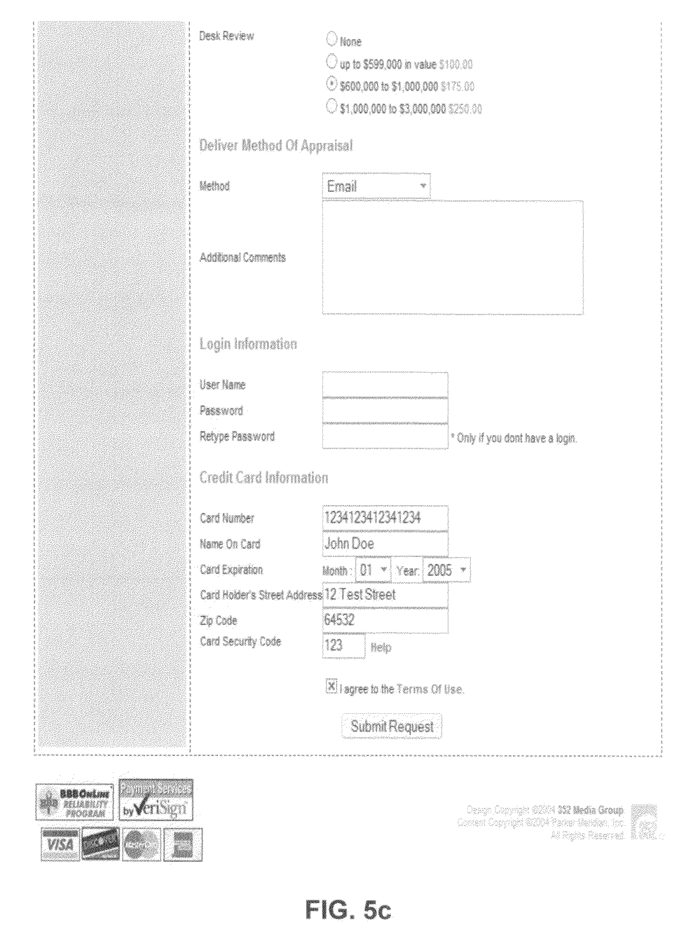

FIG. 5 shows the system may also include memory which stores an appraisal base. The appraisal base will be a database file which will be formulated by consumers-users for submission to an appraisal job pool accessible to subscribing appraisers-users or submission to specified appraiser as a contractor. The system also includes an appraisal management/job management module which manages the creation, revision, and maintenance of job records contained in the appraisal base and job records contained in the job base. The system will also include an iterative search engine which handles queries to the appraisal base and job base. The operational features of the iterative search engine are described below. The appraisal management/job management module and the iterative search engine may be implemented through commercially available database management systems. Other conventional search and query capabilities may also be used to search the databases. FIG. 4 shows the third database monitoring the relationship between the appraiser and consumer.

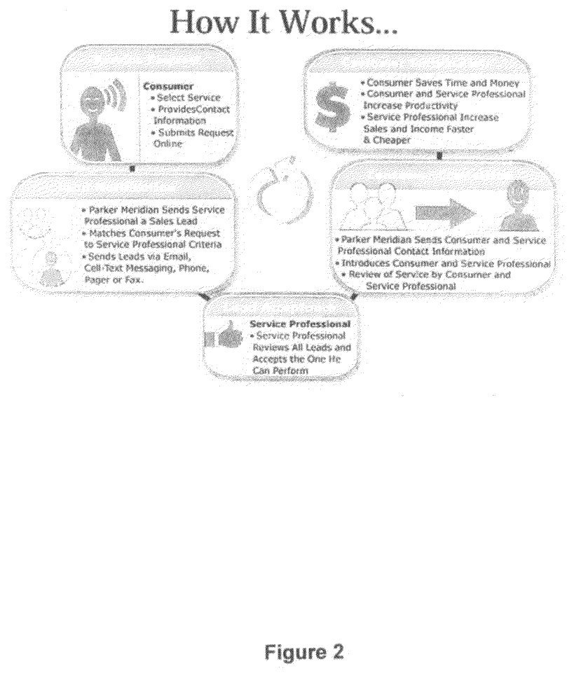

FIG. 2 shows a user walkthrough establishing access to the system according to the invention though the communication port will be presented with a variety of menus. According to the preferred embodiment, communication may be effected through hyper text markup language (“html”) pages.

It is contemplated that users accessing the system by computer communications will be either “appraisers” or “consumers.” Any user who is not a consumer-user will be treated as an appraiser-user. Consumer-users are those users who are authorized to post jobs to the job base or retrieve contact information from the appraiser pool.

FIG. 9 shows an authorized appraiser-user may select a job base maintenance option at the main menu. Appraiser-users may be granted “write access” to the job base through some identification or verification protocol. A password system or source terminal identification number may be utilized to verify authority for “write access.”

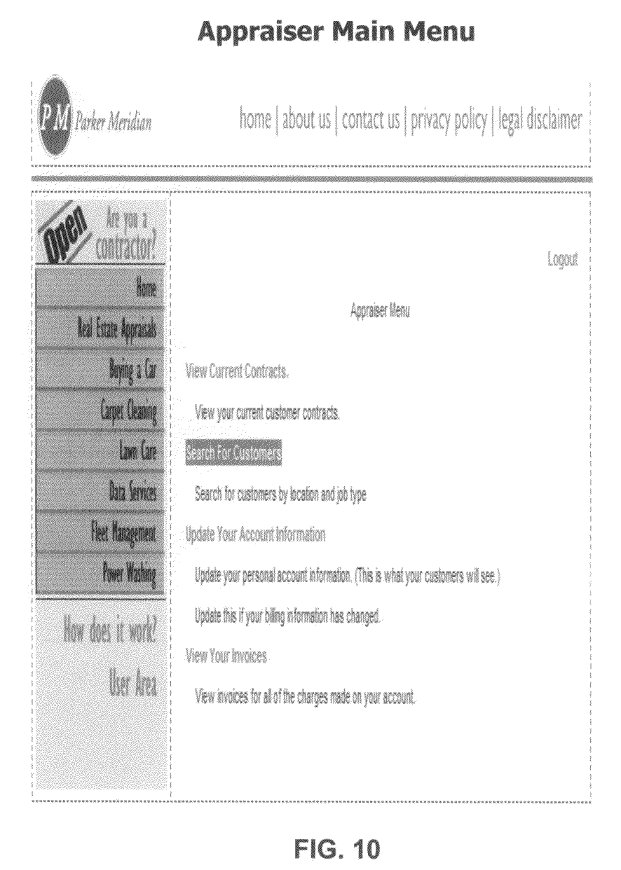

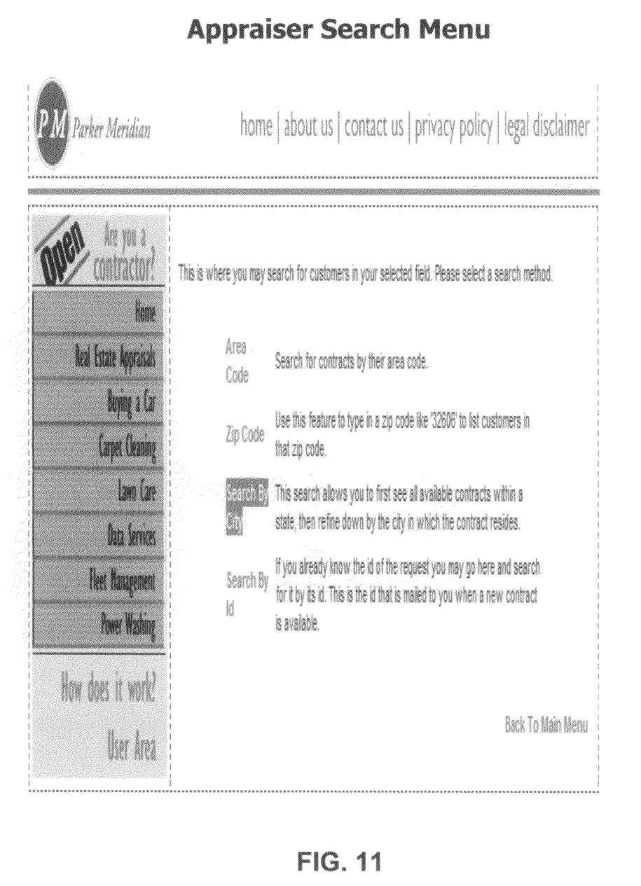

FIG. 10 shows an authorized appraiser-user elects to access job posting maintenance, appraiser may have an option of accepting a new job posting or another job record in the job base, accessing a current posting (job record), or retrieving appraisals (job records). When creating a new job record, a consumer-user may be presented with a form to be filled out on-line, or the consumer-user may upload a prepared job record to the job base. When creating a new job record on-line, a consumer-user may respond to prompts to fill the job record fields. The consumer-user may enter narrative for a job description and information for the search parameters. FIG. 11 shows any search parameter field which has a restriction on available entries may be presented in the form of a menu. If the number of available entries exceeds a predetermined amount, the entries may be presented in a scroll bar window. The entries may be selected by the user, for example, by using a mouse pointer to click on appropriate entries. For example, the discipline field will be limited to certain predetermined disciplines. The consumer-user posting a job may be required to select a discipline only from a predetermined list appearing in a menu.

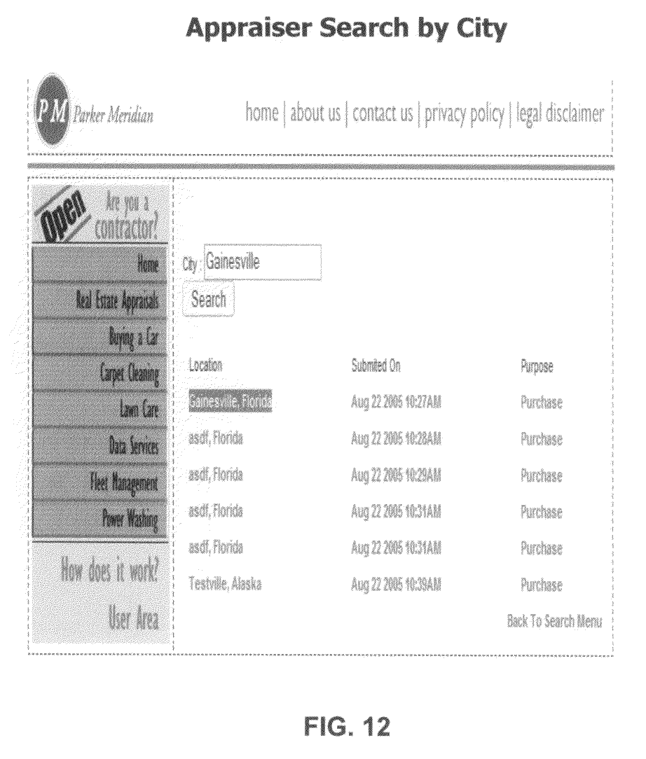

FIG. 12 shows when an authorized consumer-user elects to access current job postings, a query may be utilized in order to locate an individual or group of job records. The system will verify that the user has “write access” or authority to modify the job records. The job records may be presented as a form displayed to the user and the user may modify the fields as deemed appropriate. Alternatively, a consumer-user may elect to delete any job record, provided he has appropriate authority.

An authorized user may also be presented with an option of retrieving appraisals (job records) for the jobs it has posted on the system, i.e., corresponding to its job records. By selecting the option to retrieve appraisers (job records), the process control module will instruct the appraisal management/job management module to retrieve all job records which designate specified job records from the job base. The mechanism for creating a job record designated as an appraisal for a particular job will be described below.

As an alternative to requiring on-line access to appraisal records tagged as submission for jobs, the system may be configured to periodically query the job base for job records which are related to job records and, therefore, constitute appraisals for specific job postings. The job records thus returned may be sent by E-mail, facsimile or otherwise to the appropriate appraiser-user. Alternatively, the system may be configured to forward the job record any time a consumer-user posting for a predetermined appraisal is placed in the job base.

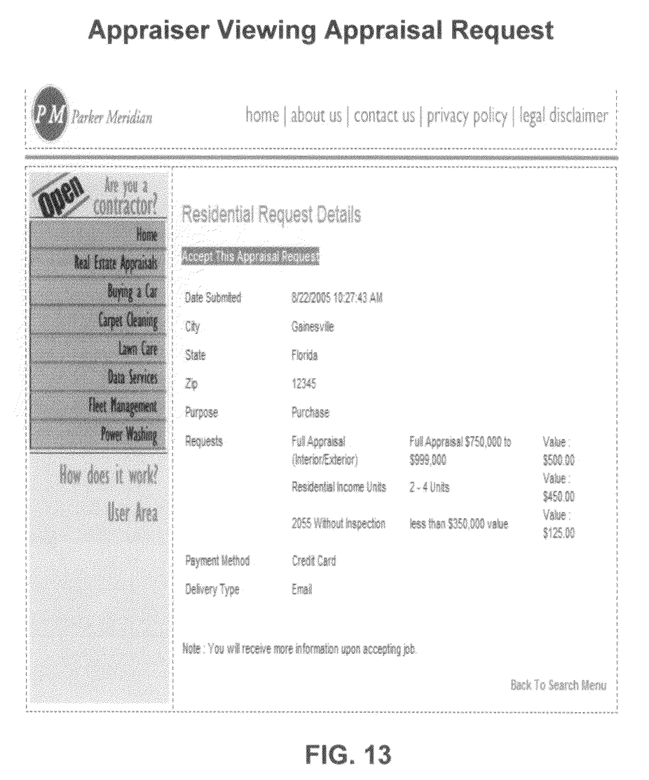

As described above, when accessing the system a user is presented with an options menu. The options menu will also include the option of submitting an appraisal to the job base (creating or modifying a resume record), searching the job base, or searching the job base in addition to the option of creating or modifying a job record (maintaining the job base). As with the option of maintaining the job base, the option of searching the appraisal base may be restricted to authorized users who subscribe to that portion of the service. FIG. 13 shows an appraiser reviewing an appraisal request by the consumer.

When a user selects the option of creating an appraisal or creating a job posting, the process control unit submits commands to the appraisal management/job management module which, in turn, passes information for the fields of the specified base from the user's computer through the communication port into the selected database record. The job base is an electronically stored database. The job base is a collection of appraisal records stored in electronically readable memory.

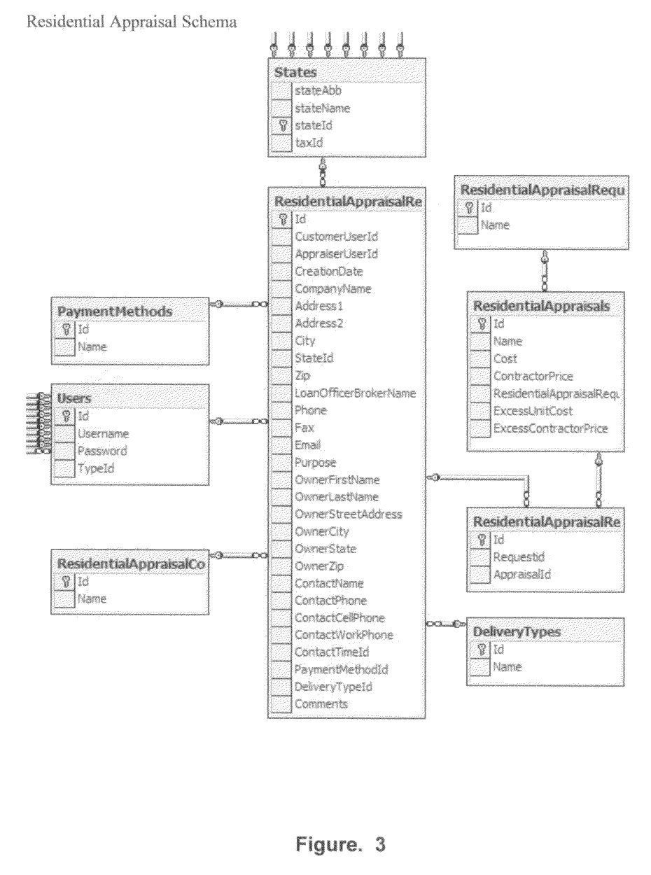

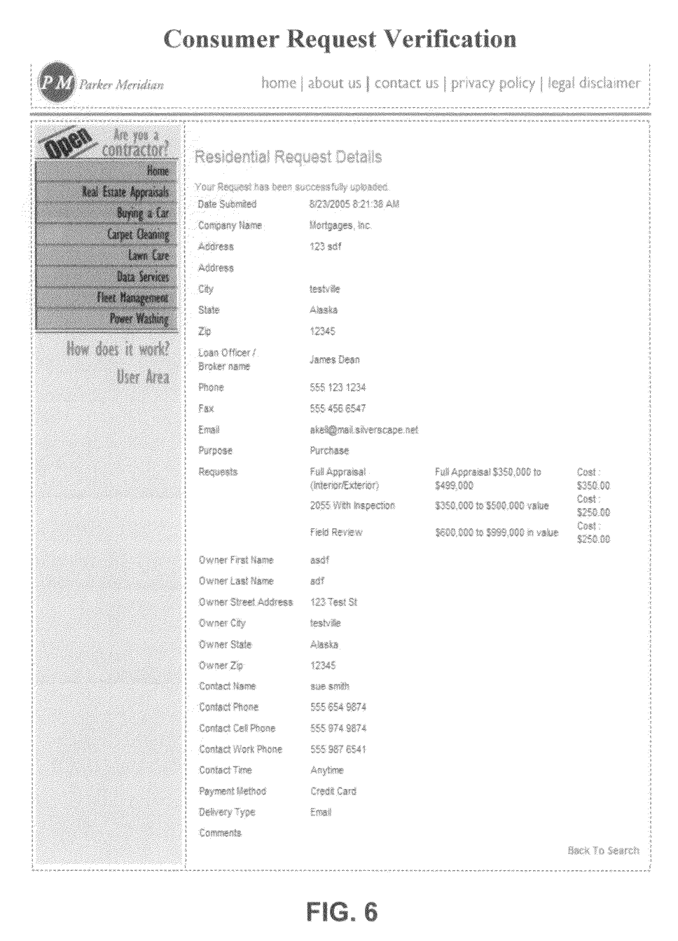

FIG. 3 and FIG. 6 shows the appraisal records will advantageously include fields specifying name, address, telephone number, E-mail address and narrative fields containing descriptive information of the subject property, borrower, present owner, address, city, state, zip, home phone number, work phone number, cellular number, property type, reason, appraisal type, interior photos, estimated value, payment type, comments, login information, credit card information, other payment terms like line of credit, payment pre closing or post closing of mortgage or note.

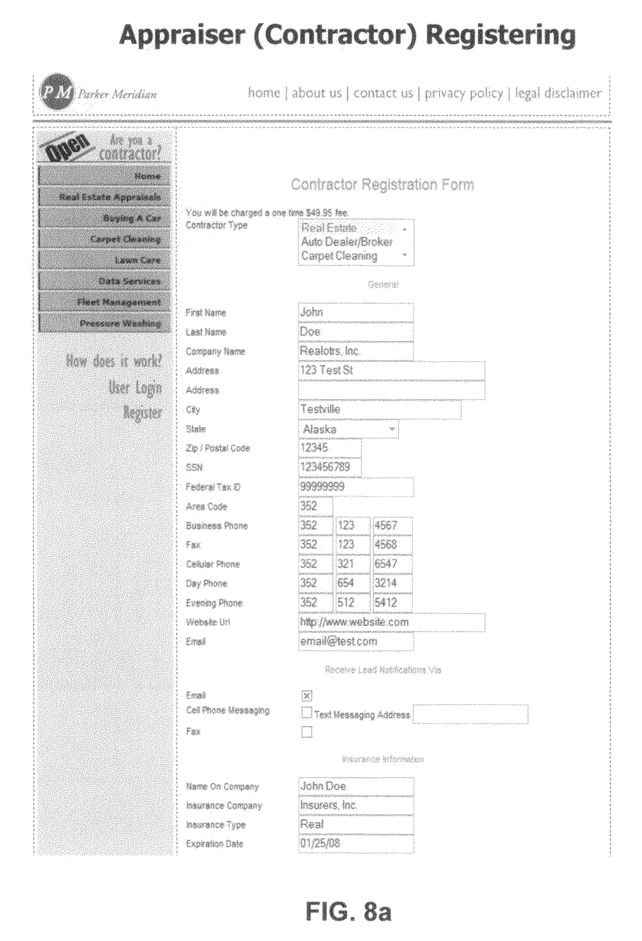

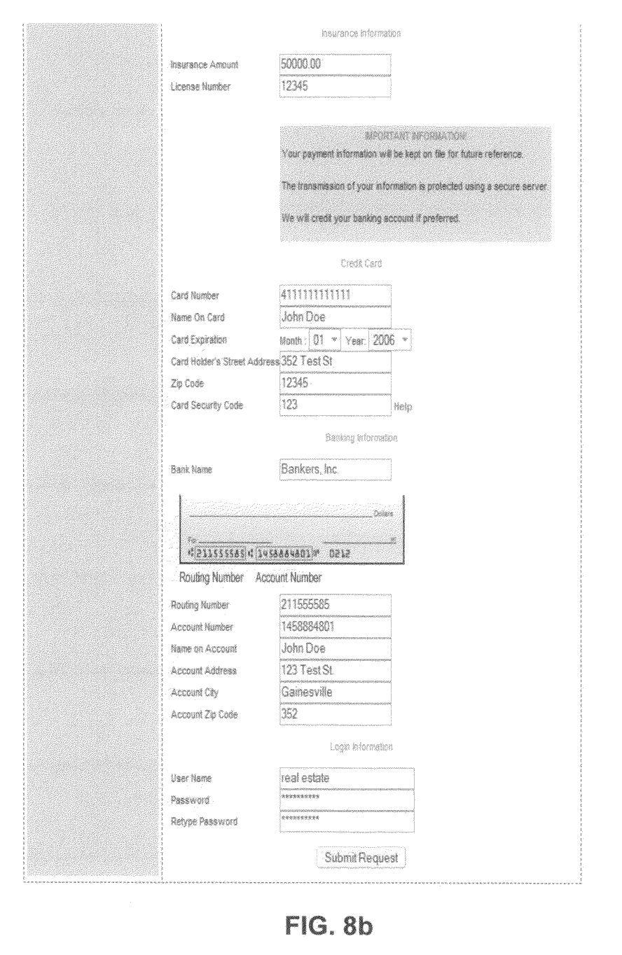

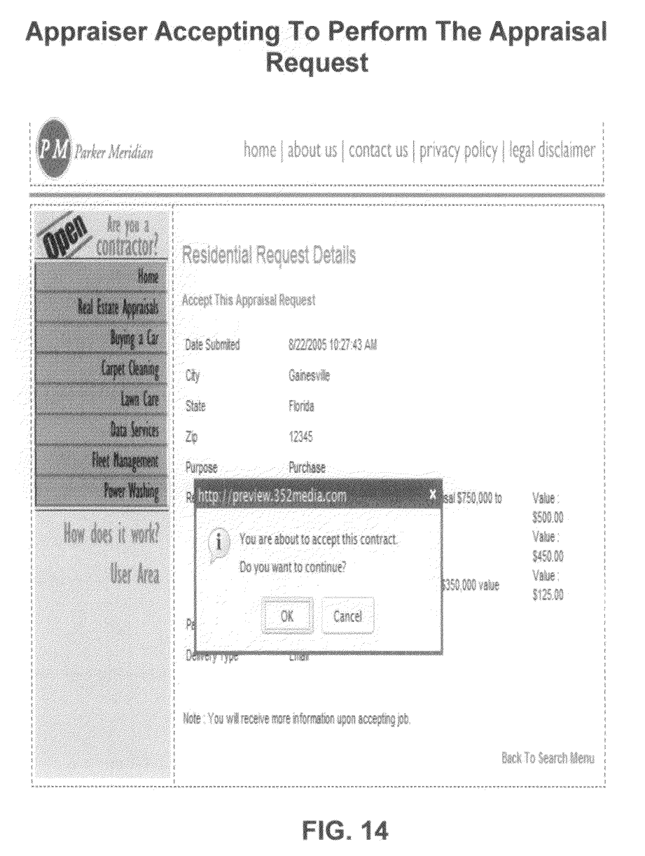

FIG. 8 shows the fields in an appraisal record may be populated through use of a form presented to the user. The resume record may also include fields for a user password and a field that is used to designate the record as a submission to an accessible resume pool or a specified job. If the field designates a specified job, it may include a job record identification. The user-consumer will be presented the option of maintaining the appraisal job on the system without submission; submission of the appraisal to a job pool accessible to subscribing appraiser; or submission of the appraisal as a job to any posted job listing. FIG. 14 shows an appraiser acceptance to perform the appraisal request.

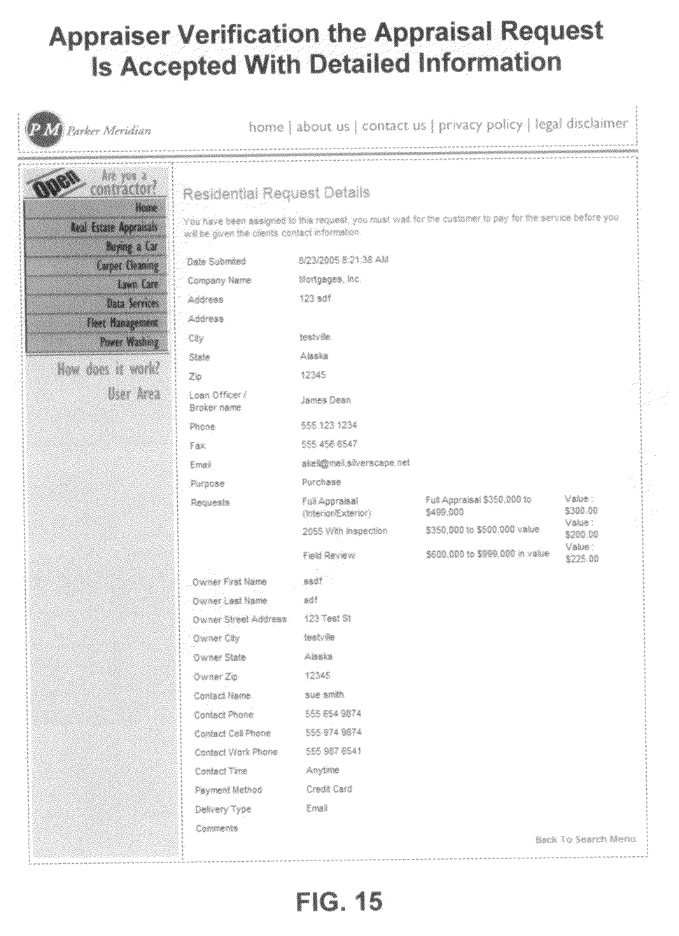

In the event the appraisal is submitted to an accessible pool, a mechanism may be provided to prevent access to the appraisal by specified parties in order to protect a consumer-user from having an appraiser, who is also an appraiser-user, learn that the consumer-user is seeking a new position. Access may be restricted by including a field in the job record identifying appraisers which will not be granted access to the job record even though they may have access to the job pool or by a fuzzy logic inquiry into the current appraiser field when any subscribing appraiser queries the appraisal pool. An appraisal may be “submitted” as a job posting by relating the appraiser to a job record by placing a job record identification into an appropriate field in the job record. FIG. 15 shows the appraiser acceptance with detailed consumer information.

It is to be understood that the system is not limited to using the physical file; record and field structures described herein and other physical structures, which are logically equivalent, will be applicable equivalent for the purpose of this invention.

The iterative search engine will be invoked when a consumer-user selects the appraisal search option from the opening menu or when an appraiser-user selects the appraisal search option to search the job pool. When the iterative search engine is invoked to search the job base, a number of scroll bar type menus may be presented to a user. The scroll bar menus can correspond to the various search parameters and fields of a job record. The menu presents predetermined options corresponding to the available entries for the various fields. The user then selects query entries from the options presented.

According to an advantageous feature, fields, which are not limited to predetermined entries, may be queried using a key word, address or literal string inquiry. The query will return an indication of the number of records, which satisfy the query. If a plurality of records is identified, additional iterations of the search may be executed. Each of the scroll bar menus is represented. However, on re-presentment, rather than displaying the entire universe of available entries for each field only the entries which correspond to entries of records selected in the previous iteration are displayed.

The user can then further narrow the selections and submit additional iterative inquiries. When the query narrows selected records to the satisfaction of the user, the user may request display of predetermined portions of the selected record(s). The user is then presented with the option of submitting a previously established job record as an appraisal job; modifying a previously established appraisal record as a job; or formulating a appraisal record as a job. The appraisal record may advantageously be designated as an job for a selected job by marking a job field with a job identification number corresponding to a record in the job base. As discussed above, the appraisal record so designated may be transmitted or made available to the appraiser.

If an appraiser-user selects the appraisals pool option; the system may invoke the iterative search engine to query job records designated for the appraisal pool. The appraiser's pool may be a subset of records in the job base. They may be so designated by the presence of special characters in a job-identification field. The system may impose a restriction on records, which are returned to an appraiser-user to ensure that any appraisal created by a consumer-user who is in partnership of the appraiser-user will not be made available to that appraiser-user. According to the preferred embodiment, the information returned to the appraiser-user during an appraisal pool query will not include contact information.

The system may invoke an accounting subsystem when an appraiser-user requests contact information. According to this feature, appraiser-users may view contact information on consumer-users, if the job is accepted.

A system according to the invention has been made accessible through the World Wide Web with a URL of http://www.pmparkermeridian.com.

The system has been described with reference to a preferred embodiment particularly suited exchange appraisal job information; managing the submission of appraisals from the consumer and managing appraisers and appraisal job database.

Thus an electronic automated appraisal information exchange and management system has been described. While the invention has been described and shown in connection with the preferred embodiment, it will now be apparent to one of ordinary skill in the art that many changes and modifications may be made without departing from the specification and the scope of the present invention. The embodiment described above is an example and should not be construed as limiting of the claims except where reference to the specification is required for such construction. The claims below are set forth to define the scope of protection sought by this application.

In compliance with 37 C.F.R. 1.121(b)(3), please replace the specification submitted on Apr. 17, 2006 with this substitute specification. In compliance with 37 C.F.R. .sctn. 1.125(b), the substitute specification includes no new matter. Also enclosed is a clean version of the substitute specification.

I claim:

1. A computer system whose actions are directed by a computer program configured as a multiple database information exchange management system configured for network operations, comprising:
a first database of appraiser contact information stored in electronically readable memory;
a second database of consumer contact information stored in electronically readable memory;
A third database of relationship between appraiser and consumer stored in electronically readable memory;
a communication port suitable for transmitting and receiving data and instructions in the form of electrical signals, to and from remote computers, or any form of electric device;
a database manager for creating and updating records of said first database and said second database and said third database connected to said electronically readable memory responsive to a plurality of said remote computers, or any form of electronic device;
an iterative database query engine connected to said memory, said engine configured to permit an initial search and at least one detailed search where said subsequent search operates on the results of said first search and with matching capabilities; and
wherein said third database is a control to prohibit collusion relationship between the appraiser and consumer.

2. A system according to claim 1, wherein said first database is an appraiser database and comprises a plurality of records containing information suitable for appraisal job postings.

3. A system according to claim 1, wherein said iterative database query engine includes:
means for searching on a plurality of search key fields of a database for satisfaction of one or more conditions;
means for reporting all variables in said search key fields of records which satisfy said one or more of said conditions.

4. A system according to claim 4, wherein said search key fields include at least a geographical key and a discipline key.

5. A computer system according to claim 1, further comprising means for relating a record of said first database to a record of said second database and verifying no record in third database.

6. A computer system according to claim 5, wherein said means for relating comprises means for storing an identification of a record in said second database in a relation field of a record of said first database and verifying no record in third database.

7. A computer system according to claim 5, wherein said means for relating comprises means for storing an identification of a record in said first database in a relation field of a record in said second database and verifying no record in third database.

8. A computer system according to claim 5, wherein said means for relating comprise means for creating an entry in a relation table stored in electronically readable memory, wherein said relation entry includes identification of a record in said first database and identification of a record in said second database and verifying no record in third database.
